(19) United States
(12) Patent Application Publication
(10) Pub. No.: US 2023/0322288 A1
(43) Pub. Date: Oct. 12, 2023

(54) Handrail Assembly and Manufacturing Method Therefor, Support Frame Structure, and Child Carrier

(71) Applicant: Wondertand Switzerland AG, Steinhausen (CH)

(72) Inventor: Bo WU, Guangdong (CN)

(21) Appl. No.: 18/040,509

(22) PCT Filed: May 21, 2021
(86) PCT No.: PCT/CN2021/095262

§ 371 Date: Feb. 3, 2023

(30) Foreign Application Priority Data
Aug. 11, 2020 (CN) 202021662285.2
Dec. 28, 2020 (CN) 202011585042.8

(51) Int. Cl. B29C 63/06; B32B 7/09; B32B 9/02; B32B 9/04; B29C 63/00; B32B 1/08; B32B 7/12; B62B 9/12; B62B 9/24; B29C 63/48

(52) U.S. Cl. CPC B62B 9/24; B29C 63/0069; B29C 63/06; B29C 63/48; B32B 1/08; B32B 7/09; B32B 7/12; B32B 9/025; B32B 9/041; B62B 9/12; B29C 2063/485; B29L 2031/3029; B62B 2501/04; B62B 2501/065

(57) ABSTRACT

A handrail assembly, a manufacturing method for the handrail assembly, a support frame structure having the handrail assembly, and a child carrier. The handrail assembly comprises a handrail body, wherein the handrail body is covered with a first protective layer of a flexible structure, the first protective layer is covered with a second protective layer, the second protective layer shields the first protective layer to prevent the first protective layer from being exposed to the outside. The support frame structure comprises a front support assembly, a rear support assembly, a push rod assembly, a connecting assembly and a handrail assembly, a connecting portion of the handrail assembly being detachably connected to the connecting assembly. The handrail assembly can prevent the first protective layer from being exposed to the outside, and prevent children from accidentally swallowing the filling of the first protective layer, thereby guaranteeing the life safety of children.

### TECHNICAL FIELD

The present disclosure relates to the field of baby products, in particular to a handrail assembly and a manufacturing method therefore, a support frame structure having the handrail assembly and a child carrier.

### BACKGROUND

When a child carrier is to be designed and the safety of the child is taken for consideration, a front handrail is usually designed at its handrail that extends forward and can prevent a child from falling forward. Generally, the front handrail is covered with a protective sleeve with a buffering function. The child having strong curiosity may often bite and pull the protective sleeve of the front handrail when they are sitting in the child carrier, and the protective sleeve is made of a flexible material to provide the buffering function and is thus easily broken due to the child’s biting or pulling, so that the handrail body may be exposed to the outside to eliminate its buffering function and may be swallowed by the child to seriously endanger the child’s life safety.

Furthermore, protective covers of traditional baby carriers in the market are largely made of leathers covered with an adhesive layer and then pasted with EVA (Ethylene Vinyl Acetate Copolymer), and then a handrail tube is applied with a layer of glue evenly on a surface thereof to assemble the protective sleeve onto the handrail tube of the child carrier. It takes a long time to wait for the glue to be solidified before the protective sleeve is fixed and pasted on the handrail tube. This process is complicated, and a single person can only process one handrail assembly at one time, which consumes labor and working-hours. Moreover, a fitting effect between the protective sleeve and the handrail tube after being assembled is not good enough, and the protective sleeve and the handrail tube may not be tightly fitted, present uneven wrinkles, which greatly affects overall aesthetics of the handrail assembly and the child carrier.

Therefore, it is necessary to provide a handrail assembly, which can prevent fillings from being exposed to the outside, prevent the child from accidentally swallowing the fillings and thus guarantee the child’s life safety, and can provide a simple processing operation and a manufacturing method for the handrail assembly.

### SUMMARY

An object of the present disclosure is to provide a handrail assembly, which can prevent the fillings from being exposed to the outside and prevent the child from accidentally swallowing the fillings, thereby guaranteeing the child’s life safety.

Another object of the present disclosure is to provide a manufacturing method of a handrail assembly, which can process a plurality of handrail assemblies at one time, so that the assembled protective sleeve is tightly attached to the handrail body, thereby providing a good protection effect, and a simple processing operation.

A further object of the present disclosure is to provide a support frame structure having a handrail assembly, which can prevent the fillings from being exposed to the outside, so as to prevent the child from accidentally swallowing the fillings, thereby guaranteeing the child’s life safety.

A still another object of the present disclosure is to provide a child carrier with a support frame structure having a handrail assembly, which can prevent the fillings from being exposed to the outside, so as to prevent the child from accidentally swallowing the fillings, thereby guaranteeing the child’s life safety.

To achieve the above objects, the present disclosure provides a handrail assembly, which includes a handrail body. The handrail body is covered with a first protective layer having a flexible structure, the first protective layer is covered with a second protective layer, and the second protective layer shields the first protective layer to prevent the first protective layer from being exposed to the outside.

Compared with the prior art, in the handrail assembly of the present disclosure, the handrail body is covered with a first protective layer having a flexible structure as the fillings, the flexible structure has a buffering function to prevent the child from bumping against the hard handrail assembly when leaning forward, and the first protective layer of the handrail assembly is covered with a second protective layer having anti-biting function. The second protective layer has wear resistance, strong toughness, good sealing performance and pull resistance, and the second protective layer shields the first protective layer from being exposed to the outside, that is, the second protective layer completely encloses the first protective layer therein, to prevent the fillings, i.e., the first protective layer from being exposed to the outside, and prevent the child from accidentally swallowing the first protective layer, thereby guaranteeing the child’s life safety. Meanwhile, the two-layer protective layer structure not only has a good protection effect on the child, but also has good strength, durability and long service life. Especially, the second protective layer is made of leather, which can greatly improve texture of the handrail assembly and improve the overall grade and appearance of the child carrier.

Preferably, both ends of the second protective layer are respectively bent and extended to form bending sections covering both ends of the first protective layer. As the end of the first protective layer is easy to be exposed, the bending section is provided to greatly prevent the end of the first protective layer from being exposed, and prevent the child from biting and accidentally swallowing, so as to ensure the child’s life safety.

Preferably, a tip of the bending section extends to an end of the handrail body and is at least partially attached to the end of the handrail body. In this way, the length and the covering area of the bending section can be increased, so that the end of the first protective layer can be less likely to be exposed, and the child’s life safety can be guaranteed.

Preferably, the bending section of the present disclosure forms a penetrated hollow structure, and a central area of the end of the handrail body is exposed to the outside through a penetrated opening of the hollow structure, thereby facilitating the handrail body to pass through the protective sleeve formed by the combination of the first protective layer and the second protective layer, and greatly improving the production and processing efficiency of the handrail assembly.

Preferably, the bending sections of the second protective layer bypass the ends of the first protective layer and are embedded into a contact surface between the first protective layer and the handrail body, and the bending sections are connected to the handrail body. Thus, a length of the covered end of the first protective layer is increased, that is, both outer and inner sides of the end of the first protective layer are covered, and the bending section is clamped by the handrail body and the first protective layer, so that the bending section cannot be turned out, thereby better preventing the end of the first protective layer from being exposed, preventing the child from biting the exposed first protective layer and accidentally swallowing, and better ensuring the child’s life safety.

Preferably, the bending section of the present disclosure forms a hollow tubular structure which is sleeved outside the handrail body. In this way, when the handrail body passes through the first protective layer and the second protective layer, the bending section will not be turned out, so as to ensure the effect that the bending section covers the end of the first protective layer and greatly prevent the end of the first protective layer from being exposed to the outside.

Preferably, the handrail body of the present disclosure is a rigid tube having a hollow structure. The hollow handrail body can not only reduce the weight of the handrail assembly to reduce the overall weight of the child carrier, and facilitate for use, storage and transportation, but also has less processing materials and low cost.

Preferably, the handrail body of the present disclosure has an integrated structure. With this arrangement, it is convenient for processing and molding, and the integrated structure has good strength, durability and long service life.

Preferably, the first protective layer of the present disclosure has an elastic structure. The elastic structure has a buffering function, which can prevent the child from bumping against the hard handrail assembly when leaning forward.

Preferably, the first protective layer of the present disclosure is a soft rubber structure or a foam structure. The protective layer with this structure not only has a good buffering and protection effect, but also is easy to be obtained, and has low purchasing cost, which greatly reduces the overall cost of the handrail assembly and the child carrier.

Preferably, the second protective layer of the present disclosure is a leather structure. The leather structure is anti-slip, durable, and greatly-textured and has high grade, which can greatly improve the overall texture of the handrail assembly and the child carrier, and enhance users’ interest and purchase desire.

The present disclosure also provides a manufacturing method of the handrail assembly, wherein the handrail assembly is the handrail assembly according to any one of the above technical solutions, and the manufacturing method includes following steps of:
(1) providing a first protective layer, a second protective layer and a first adhesive layer, wherein the first adhesive layer is provided on a surface of the first protective layer in contact with the handrail body and is made of a hot-melt material;
(2) adhering and fixing the first protective layer and the second protective layer to form a base material layer having an integrated structure;
(3) curling the base material layer into a protective sleeve matched with the handrail body, wherein the protective sleeve has a cylindrical structure, and the first adhesive layer is located at an inner side of the protective sleeve;
(4) inserting the handrail body, which is matched with the protective sleeve, into the protective sleeve to form a handrail assembly blank;
(5) baking the handrail assembly blank until the first adhesive layer is completely melted;
(6) cooling a baked handrail assembly blank to form a required handrail assembly.

Compared with the prior art, the protective sleeve of the present application is sleeved on the surface of the handrail body and then baked at a high temperature, the first adhesive layer is in a molten state at the high temperature, so that the protective sleeve and the handrail body are adhered and fixed, and the assembled protective sleeve is tightly adhered with the handrail body, and has a fixed position. The manufacturing method of the handrail assembly of the present disclosure may process a plurality of handrail assemblies at one time, which can provide a simple processing operation, reduce the number of processing procedures, save the labor cost, and greatly improve the production efficiency; meanwhile, the protective layer of the handrail assembly manufactured by this method is not easy to loosen, so as to ensure its position to be fixed, and reduce a possibility of loosening between the two protective layers and between the protective sleeve and the handrail body, thereby greatly guaranteeing the protection effect of the protective sleeve and improving the use safety to greatly guarantee the child’s life safety.

Preferably, the step (2) of the present disclosure further includes following steps of: (21) providing a second adhesive layer, wherein the second adhesive layer is made of a hot-melt material and is provided between the first protective layer and the second protective layer; (22) adhering the first protective layer and the second protective layer into an integrated structure by being baked at a high temperature to form a base material layer. In this way, the second adhesive layer is baked at a high temperature to fix the first protective layer and the second protective layer into an integrated structure. This adhering and fixing method is not only reliable, but also providing close attachment to ensure that the first protective layer and the second protective layer will not be loosened or layered therebetween, thereby providing strong sense of an integrated structure in visual effect, greatly improving the quality and appearance of the protective sleeve, and having a good protection effect.

Preferably, the step (2) of the present disclosure further includes following steps of: (21) applying a glue between the first protective layer and the second protective layer; (22) adhering the first protective layer and the second protective layer into the integrated structure to form the base material layer after the glue is solidified. As for the fixing method using the glue, the operation is simple and the cost is low.

Preferably, the step (2) of the present disclosure further includes following steps of: (23) fixedly connecting the bending sections with the first protective layer. In this way, when the protective sleeve and the handrail body are fixed together, the bending section may be synchronously and fixedly connected to the first protective layer to ensure that the end of the first protective layer is not exposed to the outside, thereby preventing the child from biting and accidentally swallowing, to ensure the child’s life safety.

Preferably, the step (23) of the present disclosure is prior to the step (22), and the bending sections is capable of being fixed with the first protective layer together with the second protective layer. In this way, the fixing of the bending section and the fixing of the protective sleeve and the handrail body can be carried out at the same time, and the production efficiency is great.

Preferably, in the step (23) of the present disclosure, the bending sections are fixedly connected to the first protective layer by baking the second adhesive layer; or, in the step (23), the bending sections are fixedly connected to the first protective layer by the glue. The bending section may be fixedly connected to the first protective layer by these two methods, and the fixing method is simple and reliable, so that the bending section is not easy to loosen.

Preferably, the step (3) of the present disclosure further includes a step of curling and sewing or manually sewing the base material layer into a protective sleeve matched with the handrail body. The protective sleeve is formed by sewing or manually sewing, which not only provides a simple manner and a convenient production and processing, but also forms a sewing thread at a joint of the protective sleeve, and improves the texture of the protective sleeve.

Preferably, each of the first adhesive layer and the second adhesive layer of the present disclosure has a membrane structure. The adhesive layer having the membrane structure has advantages of good flatness and ductility and easy to be placed and spread, to ensure that the adhesive layer is fixed without dislocation or shifting during subsequent baking and hot melting, thereby facilitating subsequent baking and hot melting, and to ensure the strength after being adhered such that the two protective layers cannot be loosen and the protective sleeve and the handrail body cannot be loosen, and thus ensure that the protective sleeve has a good protection effect.

Preferably, each of the first adhesive layer and the second adhesive layer is selected from one of a PU (polyurethane) hot melt adhesive membrane, a TPU (thermoplastic polyurethanes) hot melt adhesive membrane, a PP (polypropylene) hot melt adhesive membrane, a PS (general purpose polystyrene) hot melt adhesive membrane and a PA (polyamide). These hot melt adhesive membranes can provide a good adhering effect, a relatively low production cost, and also convenient production and processing, so that the production efficiency can be improved greatly; meanwhile, the hot melt adhesive membrane has a smooth surface, which facilitates the handrail body to pass through the protective sleeve, so as to facilitate the production and processing and improve the production and processing efficiency.

Preferably, the first adhesive layer and the second adhesive layer of the present disclosure use different hot melt adhesive membranes. Due to different adhesive degrees between different materials, the hot melt adhesive membranes are configured different, so that the adhering firmness between the first protective layer and the second protective layer and the adhering firmness between the protective sleeve and the handrail body can be ensured.

Preferably, the first adhesive layer of the present disclosure is adhered and fixed with the first protective layer by hot pressing or vacuum adsorption or a double-sided adhesive layer; and/or, the second adhesive layer is adhered and fixed with the second protective layer or the first protective layer by hot pressing or vacuum adsorption or a double-sided adhesive layer. In this way, it is convenient to fix the first adhesive layer and the second adhesive layer, and because of this reliable fixing, when the adhesive layer is baked, the adhesive layer cannot be shifted or misplaced, so that the adhering firmness between two protective layers and the firmness and tightness of adhering between the protective sleeve and the handrail body can be ensured.

Preferably, a baking temperature in step (5) and step (22) of the present disclosure ranges from 80° C. to 150° C. Within this range, it can not only ensure the firmness of the direct adhering between the protective sleeve and the handrail body greatly, but also prevent thermal deformation to facilitate the appearance of the protective sleeve and the protection effect of the protective sleeve.

Preferably, a baking time in step (5) and step (22) of the present disclosure ranges from 2 minutes to 6 minutes. Within this range, it can not only ensure the firmness of adhering between the protective sleeve and the handrail body, but also prevent thermal deformation of the protective sleeve and the handrail body, to provide reasonable production and processing time and improve the production and processing efficiency.

The present disclosure also provides a support frame structure that includes a front support assembly, a rear support assembly, a push rod assembly and a connecting assembly for assembling and connecting the front support assembly, the rear support assembly and the push rod assembly and also includes the handrail assembly as mentioned above, wherein a connecting portion of the handrail assembly is detachably connected to the connecting assembly.

Preferably, the support frame structure of the present disclosure further includes an inserting element provided at a connecting portion, and the inserting element is detachably connected to the connecting portion.

Preferably, the connecting assembly of the support frame structure of the present disclosure is provided with a receiving element matched with the inserting element of the handrail assembly, and the handrail assembly is detachably connected to the connecting assembly through a plug-in connection between the inserting element and the receiving element. The handrail assembly is connected to the receiving element through the inserting element, so that the handrail assembly and the connecting assembly can be assembled and disassembled conveniently and quickly, which facilitates allowing the child to sit and get up. When it is required to store the support frame structure, the handrail assembly may be disassembled to reduce a volume of the support frame structure after being folded and save space and to facilitate for storage.

Preferably, the support frame structure of the present disclosure is a stroller structure, a baby bed frame structure or a baby seat structure.

The present disclosure further provides a child carrier that includes a child carrier body and the support frame structure as mentioned above for supporting the child carrier body.

### BRIEF DESCRIPTION OF THE DRAWINGS

FIG. 1 is a structural schematic view of a child carrier of the present disclosure.

FIG. 2 is a structural schematic view of a handrail assembly of the present disclosure.

FIG. 3 is a partially cross-sectional structural view of a first embodiment of the handrail assembly according to the present disclosure.

FIG. 4 is a partially cross-sectional structural view of a second embodiment of the handrail assembly according to the present disclosure.

FIG. 5 is a partially cross-sectional structural view of a third embodiment of the handrail assembly according to the present disclosure.

FIG. 6 is a partially cross-sectional structural view of a fourth embodiment of the handrail assembly according to the present disclosure.

FIG. 7 is a flow chart of a manufacturing method of the handrail assembly according to the present disclosure.

List of Reference Numbers:

| | |
|---|---|
| Child Carrier 100 | Support Frame Structure 1 |
| Front Support Assembly 20 | Rear Support Assembly 30 |
| Push Rod Assembly 40 | Connecting Assembly 50 |
| Handrail Assembly 10 | Handrail Body 11 |
| First Protective Layer 12 | Second Protective Layer 13 |
| First Adhesive Layer 14 | Second Adhesive Layer 15 |
| Supporting Portion 111 | Connecting Portion 112 |
| Folding Section 131 | Receiving Element 51 |
| Inserting Element 51′ | Mounting Hole 52 |

### DETAILED DESCRIPTION

In order to explain the technical contents and structural features of the present disclosure in detail, the description will be made in conjunction with the embodiments and the accompanying drawings.

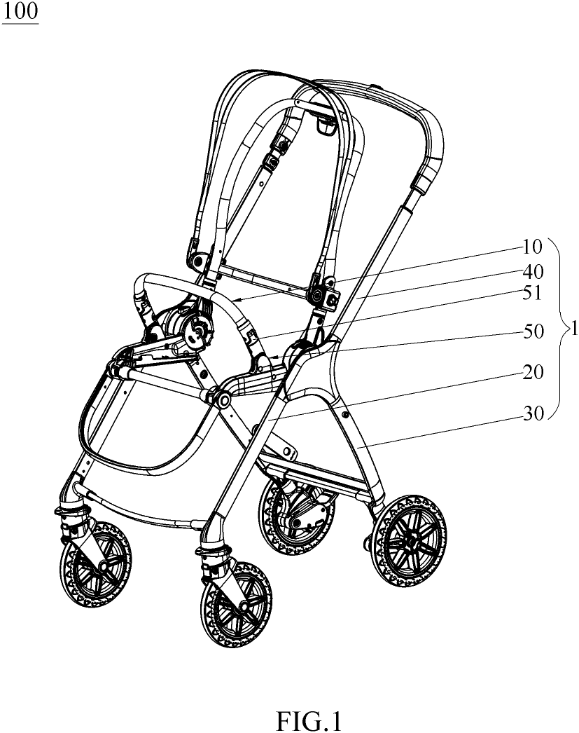

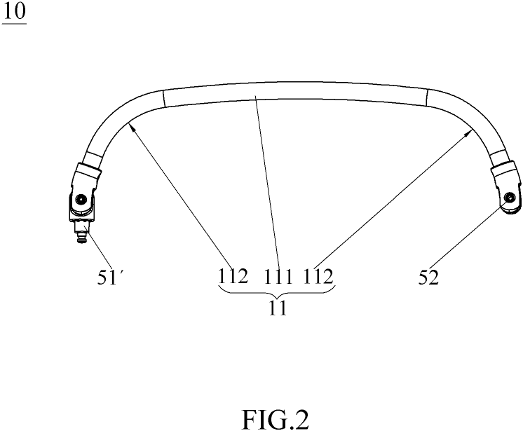

Referring to FIGS. 1 and 2, a child carrier 100 of the present disclosure includes a child carrier body and a support frame structure 1 for supporting the child carrier body. For example, the child carrier 100 may be a stroller, but it is not limited thereto. The child carrier 100 may also be a baby bed or a baby seat. The support frame structure 1 of the baby carrier according to the present disclosure includes a handrail assembly 10, a front support assembly 20, a rear support assembly 30, a push rod assembly 40 and a connecting assembly 50 for assembling and connecting to the front support assembly 20, the rear support assembly 30 and the push rod assembly 40. The handrail assembly 10 includes two connecting portions 112 for connecting to the connecting assembly 50, and the connecting portions 112 is provided with an inserting element 51′ and a mounting hole 52. The inserting element 51′ is fixed to the connecting portion 112 by fitting a screw to the mounting hole 52, and the connecting portion 112 is detachably connected to the inserting element 51′ by fitting the screw to the mounting hole 52. The connecting assembly 50 is provided with a receiving element 51 matched with the inserting element 51′ of the handrail assembly 10, and the handrail assembly 10 may be detachably connected to the connecting assembly 50 through a plug-in connection between the inserting element 51′ and the receiving element 51.

### The First Embodiment

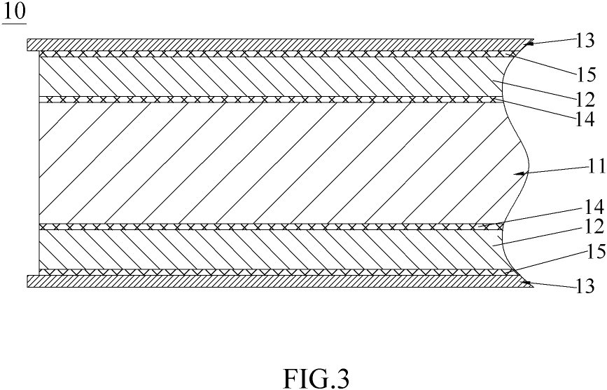

As shown in FIGS. 2 and 3, the handrail assembly 10 of the present disclosure includes a handrail body 11 having a hollow structure. The handrail assembly 10 includes a supporting portion 111 and two connecting portions 112 with the same structure. Specifically, the two connecting portions 112 with the same structure are bent and extended along both ends of the supporting portion 111, and the connecting portions 112 of the handrail assembly 10 are detachably connected to the connecting assembly 50.

Specifically, the handrail body 11 has an integrated structure, and is a rigid tube with a hollow structure, specifically a metal tube with a hollow structure. It not only has good strength, but also can reduce the weight of the handrail assembly to reduce the overall weight of the child carrier, facilitate for use, storage and transportation, and have less processing materials and low cost. Also, the integrated structure is not only convenient to be processed and molded, but also has good strength, durability and long service life.

In addition, the handrail body 11 is covered with a first protective layer 12 having a flexible structure, and the first protective layer 12 is covered with a second protective layer 13 having anti-biting function, and the second protective layer 13 shields the first protective layer 12 to prevent the first protective layer 12 from being exposed to the outside, such that the first protective layer 12, as a filling, has a buffering function due to its flexible structure, which can prevent the child from bumping against hard handrail assemblies when leaning forward, and a second protective layer 13 is also provided to shield and prevent the first protective layer 12 from being exposed to the outside. The second protective layer 13 may completely enclose the first protective layer 12, which can prevent the fillings, i.e., the first protective layer 12 from being exposed to the outside, and prevent the child from accidentally swallowing the fillings, i.e., the first protective layer 12, thereby guaranteeing the child’s life safety. Meanwhile, a structure of the protective sleeve formed by two protective layers not only has a good protection effect for the child, but also has good strength, durability and long service life. Especially, the second protective layer 13 is made of leather, which can greatly improve the texture of the handrail assembly, that is, the overall grade and appearance of the child carrier.

More specifically, the first protective layer 12 has an elastic structure. The elastic structure has a buffering function, to prevent the child from bumping against the hard handrail assembly when leaning forward. More specifically, the first protective layer 12 has a foam structure, specifically EVA foam in this embodiment. The protective layer with this structure not only has a good buffering and protection effect, but also is easy to be obtained, and its purchasing cost is low to greatly reduce the overall cost of the handrail assembly and the child carrier, especially EVA foam that has a better effect.

Then, the second protective layer 13 has a leather structure, specifically PU, which has wear resistance, strong toughness, a good sealing performance and pull resistance. Meanwhile, the PU is anti-slip, durable, and greatly-textured and has a high grade, which can greatly improve the overall texture of the handrail assembly and the child carrier, and enhance users’ interest and purchase desire.

In addition, the first protective layer 12 and the second protective layer 13 are adhered and fixed by the second adhesive layer 15, specifically, the second adhesive layer 15 is baked to be melted to adhere and fix the first protective layer 12 and the second protective layer 13. Meanwhile, the protective sleeve formed by the first protective layer 12 and the second protective layer 13 is adhered and fixed with the handrail body 11 by the first adhesive layer 14, and the first adhesive layer 14 is also baked to be melted to adhere and fix the protective sleeve with the handrail body 11.

It can be understood that the first protective layer may also be a soft rubber structure or other foam.

It can be understood that the second protective layer may also be made of a PVC (Polyvinyl Chloride), a genuine leather or other leather materials.

It can be understood that the handrail body 11 may also be a hollow plastic tube or a solid plastic tube.

### The Second Embodiment

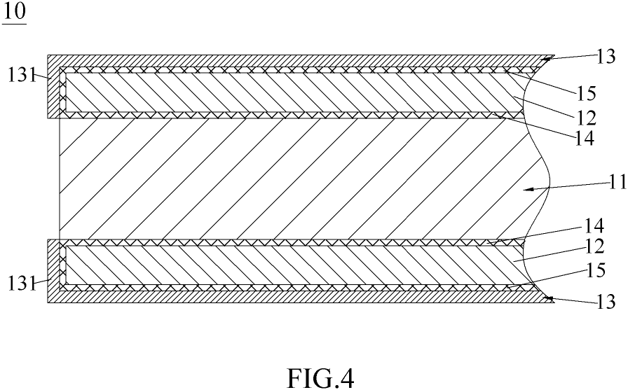

As shown in FIG. 4, both ends of the second protective layer 13 are respectively bent and extended to form bending sections 131 covering both ends of the first protective layer 12. The ends of the first protective layer 11 can be greatly prevented from being exposed to the outside by the bending sections 131, to prevent the child from biting and accidentally swallowing, thereby guaranteeing the child’s life safety.

The second protective layer 13 is bent towards the handrail body 11 to form the bending sections 131 covering the ends of the first protective layer 12. The bending section 131 forms a penetrated hollow structure, and a central area of the end of the handrail body 11 is exposed to the outside through a penetrated opening of the hollow structure, to facilitate the handrail body to pass through the protective sleeve formed by combination of the first protective layer and the second protective layer, and thereby greatly improving the production and processing efficiency of the handrail assembly.

### The Third Embodiment

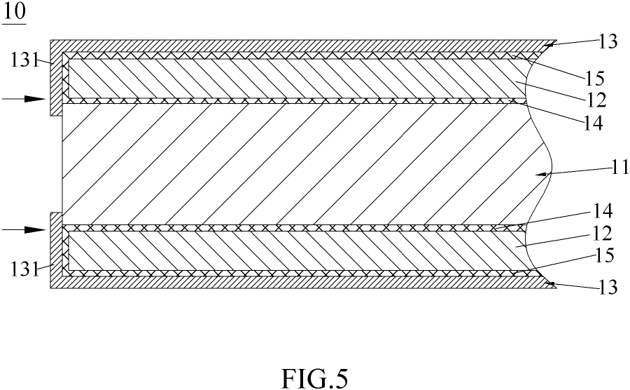

As shown in FIG. 5, a tip of the bending section 131 is further extended to and at least partially attached to the end of the handrail body 11, and a projection of the bending section 131 along a vertical sectional direction falls within the handrail body 11, wherein the vertical sectional direction may be indicated by an arrow shown in FIG. 5. Thus, a length and a covered area of the bending section can be increased, so that the end of the first protective layer can be less likely to be exposed, and the child’s life safety can be better guaranteed.

### The Fourth Embodiment

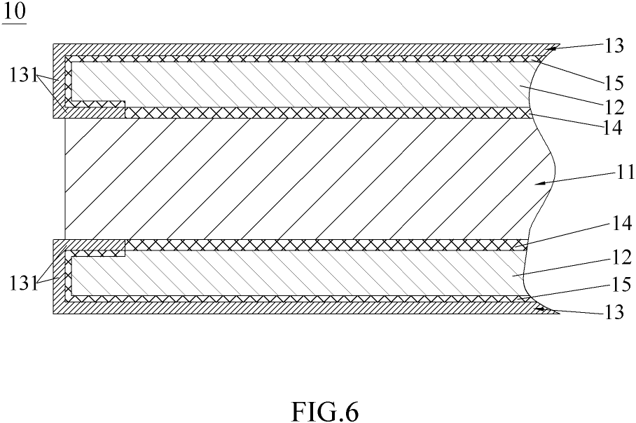

As shown in FIG. 6, the bending sections 131 of the second protective layer 13 bypass the ends of the first protective layer 12 and are embedded between the first protective layer 12 and the handrail body 11. The bending sections 131 are adhered and fixedly connected to the handrail body 11 by a glue, and the bending section 131 forms a hollow tubular structure which is sleeved outside the handrail body. Thus, the covered length of the end of the first protective layer is increased, that is, outer and inner sides of the end of the first protective layer are both covered, and the bending section is clamped by the handrail body and the first protective layer, so that the bending section cannot be turned out, thereby better preventing the end of the first protective layer from being exposed, preventing the child from biting the exposed first protective layer and accidentally swallowing, and better ensuring the child’s life safety.

Finally, as shown in FIGS. 1-6, in the handrail assembly 10 of the present disclosure, the handrail body 11 is covered with a first protective layer 12 of a flexible structure as fillings, the flexible structure has a buffering function to prevent the child from bumping against the hard handrail assembly 10 when leaning forward, and the first protective layer 12 of the handrail assembly 10 is covered with a second protective layer 13 having anti-biting function. The second protective layer 13 has properties of wear resistance, strong toughness, good sealing performance and pull resistance, and the second protective layer 13 shields the first protective layer 12 from being exposed to the outside, that is, the second protective layer 13 completely encloses the first protective layer 12, which can prevent the fillings, i.e., the first protective layer 12 from being exposed to the outside, and prevent the child from accidentally swallowing the first protective layer 12, thereby guaranteeing the child’s life safety.

In addition, in the support frame structure 1 of the present disclosure, the handrail assembly 10 is connected to the receiving element 51 through the inserting element 51′, so that the handrail assembly 10 and the connecting assembly 50 can be conveniently assembled and disassembled, which facilitates the sitting and getting up of the child. When it is required to store the support frame structure 1, the handrail assembly 10 may be disassembled, to further reduce the volume of the support frame structure 1 after folded and save space and facilitate to store.

### The Fifth Embodiment

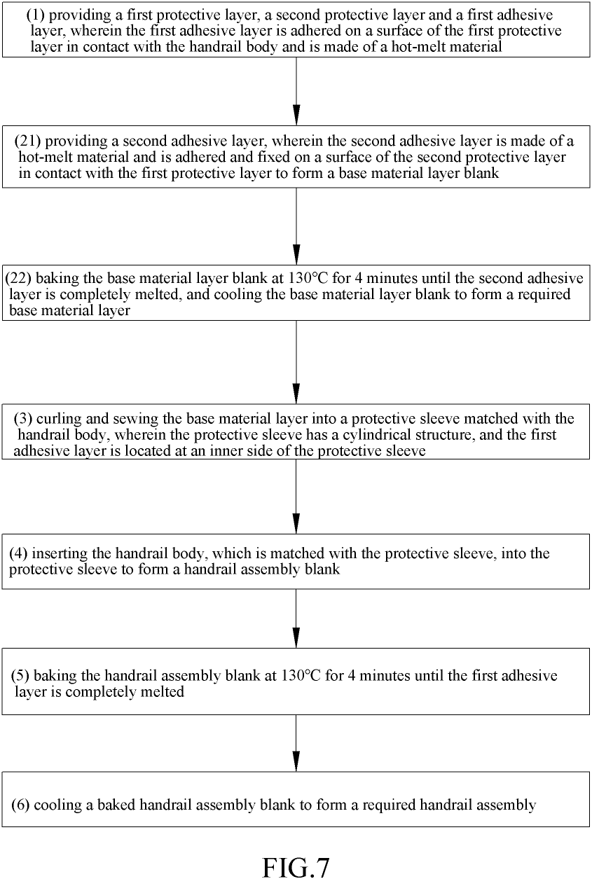

Referring to FIGS. 2 and 3, taking the specific structure of the handrail assembly described in the first embodiment as an example, the handrail assembly 10 includes a handrail body 11 that is covered with a first protective layer 12 having a flexible structure, the first protective layer 12 is covered with a second protective layer 13, and the second protective layer 13 shields the first protective layer 12 to prevent the first protective layer 12 from being exposed to the outside. In combination with FIG. 7, this embodiment also provides a manufacturing method of the handrail assembly 10, including following steps of:
(1) providing a first protective layer 12, a second protective layer 13, and a first adhesive layer 14, wherein the first adhesive layer 14 is adhered to a surface of the first protective layer 12 in contact with the handrail body 11, and the first adhesive layer 14 is made of a hot-melt material;
(21) providing a second adhesive layer 15 made of the hot-melt material, and adhering and fixing the second adhesive layer 15 on a surface of the second protective layer 13 in contact with the first protective layer 12 to form a base material layer blank;
(22) baking the base material layer blank at 130° C. for 4 minutes until the second adhesive layer 15 is completely melted, and cooling the base material layer blank to form a required base material layer;
(3) curling the base material layer into a protective sleeve matched with the handrail body 11, wherein the protective sleeve has a cylindrical structure, and the first adhesive layer 14 is located at an inner side of the protective sleeve;
(4) inserting the handrail body 11, which is matched with the protective sleeve, into the protective sleeve to form a handrail assembly blank;
(5) baking the handrail assembly blank at 130° C. for 4 minutes until the first adhesive layer 14 is completely melted;
(6) cooling the baked handrail assembly blank to form a required handrail assembly 10.

Specifically, the first protective layer 12 has a flexible and elastic structure, and the elastic structure has a buffering function, so as to prevent the child from bumping against the hard handrail assembly when leaning forward.

More specifically, the first protective layer 12 is made of a EVA foam and the second protective layer 13 is made of PU, so as to ensure that the formed protective sleeve has good protection effect, texture and high grade, and facilitate for adhering and fixing between the two protective layers. Also, it is not easy to loosen or delaminate or wrinkle, and has properties of good firmness, strong sense of integrated structure, good texture and good appearance. Meanwhile, these two materials are easy to be obtained, and the purchasing cost is relatively low, so as to reduce the production and processing cost.

Specifically, both the first adhesive layer 14 and the second adhesive layer 15 are membrane structures, which have good flatness and ductility and are convenient to be placed and spread, to ensure that the adhesive layer is fixed without dislocation or shifting during subsequent baking and hot melting, thereby facilitating subsequent baking and hot melting, ensure the strength after being adhered such that the two protective layers cannot be loosen and the protective sleeve and the handrail body cannot be loosen, and thus ensure that the protective sleeve has a good protection effect.

More specifically, the handrail body 11 is a metal tube having a hollow structure, and the first adhesive layer 14 is TPU hot melt adhesive membrane. The TPU hot melt adhesive membrane has a smooth surface, which facilitates the handrail body 11 to pass through the protective sleeve, facilitates for production and processing, and improves the production and processing efficiency. The handrail body is made of metal, and TPU hot melt adhesive membrane has better adhering effect and firmer adhering. However, it is not limited by the present disclosure, and the first adhesive layer 113 may also be one of a PU hot melt adhesive membrane, a PP hot melt adhesive membrane, a PS hot melt adhesive membrane and a PA hot melt adhesive membrane.

The first adhesive layer 14 may be adhered and fixed on a surface of the first protective layer 12 in contact with the handrail body 11 by hot pressing. In this way, the first adhesive layer 14 may be fixed conveniently and reliably, and may not fall off or shift or misplace, thereby ensuring the reliability and stability of the fixing between the protective sleeve and the handrail body. Other adhering and fixing methods, which can achieve the adhering and fixing of the first adhesive layer 14 on the first protective layer 12, are within the scope of the present disclosure.

The second adhesive layer 15 may be adhered and fixed on a surface of the second protective layer 13 in contact with the first protective layer 12 by hot pressing, so that the second adhesive layer 15 can be fixed on the second protective layer 13 in advance, which can prevent the second adhesive layer 15 from shifting or misplacing when the first protective layer 12 and the second protective layer 13 are adhered and fixed, so as to ensure the reliability of the adhering and fixing of the first protective layer 12 and the second protective layer 13. Other adhering and fixing methods, which can achieve the adhering and fixing of the second adhesive layer 15 on the second protective layer 13, are within the scope of the present disclosure.

Of course, it can be understood that a baking temperature is a constant temperature, that is, does not increase or decrease with a baking time.

It can be understood that the first protective layer 12 may also be a soft rubber structure or other foams.

It can be understood that the second protective layer 13 may also be made of PVC or a genuine leather or other leather materials.

It can be understood that the first protective layer 12 and the second protective layer 13 may also be fixed to each other by a glue, and it is simple, reliable and low in cost.

It can be understood that the first adhesive layer 14 may also be adhered to the surface of the first protective layer in contact with the handrail body by vacuum adsorption or a double-sided adhesive layer.

It can be understood that the second adhesive layer 15 may also be adhered and fixed on the second protective layer by vacuum adsorption or a double-sided adhesive layer.

It can be understood that the second adhesive layer 15 may also be adhered and fixed on the surface of the first protective layer 12 in contact with the second protective layer 13 by hot pressing, vacuum adsorption or a double-sided adhesive layer. Other adhering and fixing methods, which can achieve the adhering and fixing of the second adhesive layer 15 on the first protective layer 12, are within the scope of the present disclosure.

It can be understood that the baking temperature may also be 80° C., 85° C., 90° C., 95° C., 100° C., 105° C., 110° C., 115° C., 120° C., 125° C., 135° C., 140° C., 145° C., 150° C., etc., depending on the materials of the handrail body and the types of the hot melt adhesive membrane.

It can be understood that the baking time may also be 2 minutes, 2.5 minutes, 3 minutes, 3.5 minutes, 4.5 minutes, 5 minutes, 5.5 minutes, 6 minutes, etc., depending on the materials of the handrail body and the types of the hot melt adhesive membrane.

It can be understood that the handrail body 11 may be a hollow plastic tube or a solid plastic tube. Preferably, the first adhesive layer 14 may be a PP hot melt adhesive membrane, which has better adhering effect and firmer adhering.

### The Sixth Embodiment

Referring to FIGS. 2 and 3, taking the specific structure of the handrail assembly in the first embodiment as an example, the handrail assembly 10 includes a handrail body 11, wherein the handrail body 11 is covered with a first protective layer 12 having a flexible structure, and the first protective layer 12 is covered with a second protective layer 13, and the second protective layer 13 shields the first protective layer 12 to prevent the first protective layer 12 from being exposed to the outside. Referring to FIG. 7, this embodiment also provides a manufacturing method of the handrail assembly 10, including following steps of:
(1) providing a first protective layer 12, a second protective layer 13, and a first adhesive layer 14, wherein the first adhesive layer 14 is adhered to a surface of the first protective layer 12 in contact with the handrail body 11, and the first adhesive layer 14 is made of a hot-melt material;
(21) providing a second adhesive layer 15 made of a hot-melt material, and adhering and fixing the second adhesive layer 15 on a surface of the second protective layer 13 in contact with the first protective layer 12 to form a base material layer blank;
(22) baking the base material layer blank at 130° C. for 4 minutes until the second adhesive layer 15 is completely melted, and cooling the base material layer blank to form a required base material layer;
(3) curling and sewing the base material layer into a protective sleeve matched with the handrail body 11, wherein the protective sleeve has a cylindrical structure, and the first adhesive layer 14 is located at an inner side of the protective sleeve;
(4) inserting the handrail body 11, which is matched with the protective sleeve, into the protective sleeve to form a handrail assembly blank;
(5) baking the handrail assembly blank at 130° C. for 4 minutes until the first adhesive layer 14 is completely melted;
(6) cooling the baked handrail assembly blank to form a required handrail assembly 10.

In this method, the sewing is added in the step (3) to form the protective sleeve. In this way, the method is simple and convenient for production and processing, and a sewing thread is formed at a joint of the protective sleeve, so that the texture of the protective sleeve can be greatly improved.

Specifically, the first protective layer 12 has a flexible and elastic structure, and the elastic structure has a buffering function, so as to prevent the child from bumping against the hard handrail assembly when leaning forward.

More specifically, the first protective layer 12 is made of a EVA foam and the second protective layer 13 is made of PU, to ensure that the formed protective sleeve has good protection effect, texture and high grade, and facilitate for adhering and fixing between the two protective layers. Also, it is not easy to loosen or delaminate or wrinkle, and has properties of good firmness, strong sense of integrated structure, good texture and good appearance. Meanwhile, these two materials are easy to be obtained, and the purchasing cost is relatively low, which can greatly reduce the production and processing cost.

Specifically, both the first adhesive layer 14 and the second adhesive layer 15 are membrane structures, which have good flatness and ductility, and are convenient to be placed and spread, to ensure that the adhesive layer is fixed without dislocation or shifting during subsequent baking and hot melting, thereby facilitating subsequent baking and hot melting, and ensure the strength after being adhered such that the two protective layers cannot be loosen and the protective sleeve and the handrail body cannot be loosen, and thus ensure that the protective sleeve has a good protection effect.

More specifically, the handrail body 11 is a metal tube having a hollow structure, and the first adhesive layer 14 is a TPU hot melt adhesive membrane. The TPU hot melt adhesive membrane has a smooth surface, which facilitates the handrail body 11 to pass through the protective sleeve, facilitates for production and processing, and improves the production and processing efficiency. The handrail body is made of metal, and the TPU hot melt adhesive membrane has better adhering effect and firmer adhering. However, it is not limited by the present disclosure, and the first adhesive layer 113 may also be one of a PU hot melt adhesive membrane, a PP hot melt adhesive membrane, a PS hot melt adhesive membrane and a PA hot melt adhesive membrane.

The first adhesive layer 14 may be adhered and fixed on a surface of the first protective layer 12 in contact with the handrail body 11 by hot pressing or vacuum adsorption. In this way, the first adhesive layer 14 may be fixed conveniently and reliably, and may not fall off or shift or misplace, thereby ensuring the reliability and stability of the fixing between the protective sleeve and the handrail body. Other adhering and fixing methods, which can achieve the adhering and fixing of the first adhesive layer 14 on the first protective layer 12, are within the scope of the present disclosure.

The second adhesive layer 15 may be adhered and fixed on a surface of the second protective layer 13 in contact with the first protective layer 12 by hot pressing or vacuum adsorption, so that the second adhesive layer 15 can be fixed on the second protective layer 13 in advance, which can prevent the second adhesive layer 15 from shifting or misplacing when the first protective layer 12 and the second protective layer 13 are adhered and fixed, so as to ensure the reliability of the adhering and fixing of the first protective layer 12 and the second protective layer 13. Other adhering and fixing methods, which can achieve the adhering and fixing of the second adhesive layer 15 on the second protective layer 13, are within the scope of the present disclosure.

Of course, it can be understood that a baking temperature is a constant temperature, that is, does not increase or decrease with a baking time.

It can be understood that in step (3), the base material layer may be curled and manually sewn into the protective sleeve matched with the handrail body 11, so that the texture and grade of the protective sleeve, the handrail assembly and the child carrier can be improved.

It can be understood that the first protective layer 12 may also be a soft rubber structure or other foams.

It can be understood that the second protective layer 13 may also be made of PVC or a genuine leather or other leather materials.

It can be understood that the first protective layer 12 and the second protective layer 13 may also be fixed to each other by a glue, and it is simple, reliable and low in cost.

It can be understood that the second adhesive layer 15 may also be adhered and fixed on the surface of the first protective layer 12 in contact with the second protective layer 13 by hot pressing or vacuum adsorption. And other adhering and fixing methods, which can achieve the adhering and fixing of the second adhesive layer 15 on the first protective layer 12, are within the scope of the present disclosure.

It can be understood that the baking temperature may also be 80° C., 85° C., 90° C., 95° C., 100° C., 105° C., 110° C., 115° C., 120° C., 125° C., 135° C., 140° C., 145° C., 150° C., etc., depending on the materials of the handrail body and the types of the hot melt adhesive membrane.

It can be understood that the baking time may also be 2 minutes, 2.5 minutes, 3 minutes, 3.5 minutes, 4.5 minutes, 5 minutes, 5.5 minutes, 6 minutes, etc., depending on the materials of the handrail body and the types of hot melt adhesive membrane.

It can be understood that the handrail body 11 may be a hollow plastic tube or a solid plastic tube. Preferably, the first adhesive layer 14 may be a PP hot melt adhesive membrane, which has better adhering effect and firmer adhering.

### The Seventh Embodiment

Referring to FIGS. 2 and 4, taking the specific structure of the handrail assembly in the second embodiment as an example, the handrail assembly 10 includes a handrail body 11, wherein the handrail body 11 is covered with a first protective layer 12 having a flexible structure, and the first protective layer 12 is covered with a second protective layer 13, and the second protective layer 13 shields the first protective layer 12 to prevent the first protective layer 12 from being exposed to the outside, and both ends of the second protective layer 13 are respectively bent and extended to form bending sections 131 that cover both ends of the first protective layer 12 respectively. Referring to FIG. 7, this embodiment also provides a manufacturing method of the handrail assembly 10, including following steps of:
(1) providing a first protective layer 12, a second protective layer 13, and a first adhesive layer 14, wherein the first adhesive layer 14 is adhered to a surface of the first protective layer 12 in contact with the handrail body 11, and the first adhesive layer 14 is made of hot-melt material;
(21) providing a second adhesive layer 15 made of a hot-melt material, and adhering and fixing the second adhesive layer 15 on a surface of the second protective layer 13 in contact with the first protective layer 12 to form a base material layer blank;
(23) bending reserved sections at edges of the second protective layer downward to form bending sections and cover ends of the first protective layer;
(22) baking the base material layer blank at 130° C. for 4 minutes until the second adhesive layer 15 is completely melted, so that the second protective layer and the bending section are adhered and fixed with the first protective layer after the second adhesive layer is completely melted, and cooling the base material layer blank to form a required base material layer;
(3) curling the base material layer into a protective sleeve matched with the handrail body 11, wherein the protective sleeve has a cylindrical structure, and the first adhesive layer 14 is located at an inner side of the protective sleeve;
(4) inserting the handrail body 11, which is matched with the protective sleeve, into the protective sleeve to form a handrail assembly blank;
(5) baking the handrail assembly blank at 130° C. for 4 minutes until the first adhesive layer 14 is completely melted;
(6) cooling the baked handrail assembly blank to form a required handrail assembly 10.

In this method, the bending section and the processing method therefore are provided. As the end of the first protective layer is easy to be exposed, the bending section is provided to greatly prevent the end of the first protective layer from being exposed, and prevent the child from biting and accidentally swallowing, so as to ensure the child’s life safety; moreover, the fixing of the bending section and the fixing between the protective sleeve and the handrail body are carried out at the same time, so that the production efficiency is great.

Specifically, the reserved section is formed at a part where the edge of the second protective layer 13 is not covered by the first protective layer 12 when the first protective layer 12 is adhered and fixed on the second protective layer 13, so that the reserved section is bent downward to form the bending section 131.

Specifically, the first protective layer 12 has a flexible and elastic structure, and the elastic structure has a buffering function, to prevent the child from bumping against the hard handrail assembly when leaning forward.

More specifically, the first protective layer 12 is made of a EVA foam and the second protective layer 13 is made of PU, to ensure that the formed protective sleeve has good protection effect, texture and high grade, and facilitate for adhering and fixing between the two protective layers. Also, it is not easy to loosen or delaminate or wrinkle, and has properties of good firmness, strong sense of integrated structure, good texture and good appearance. Meanwhile, these two materials are easy to be obtained, and the purchasing cost is relatively low, which can greatly reduce the production and processing cost.

Specifically, both the first adhesive layer 14 and the second adhesive layer 15 are membrane structures, which have good flatness and ductility, and are convenient to be placed and spread, to ensure that the adhesive layer is fixed without dislocation or shifting during subsequent baking and hot melting, thereby facilitating subsequent baking and hot melting, ensure the strength after being adhered such that the two protective layers cannot be loosen and the protective sleeve and the handrail body cannot be loosen, and thus ensure that the protective sleeve has a good protection effect.

More specifically, the handrail body 11 is a metal tube having a hollow structure, and the first adhesive layer 14 is a TPU hot melt adhesive membrane. The TPU hot melt adhesive membrane has a smooth surface, which facilitates the handrail body 11 to pass through the protective sleeve, facilitates for production and processing, and improves the production and processing efficiency. The handrail body is made of metal, and the TPU hot melt adhesive membrane has better adhering effect and firmer adhering. However, it is not limited by the present disclosure, and the first adhesive layer 113 may also be one of a PU hot melt adhesive membrane, a PP hot melt adhesive membrane, a PS hot melt adhesive membrane and a PA hot melt adhesive membrane.

The first adhesive layer 14 may be adhered and fixed on a surface of the first protective layer 12 in contact with the handrail body 11 by hot pressing or vacuum adsorption. In this way, the first adhesive layer 14 may be fixed conveniently and reliably, and may not fall off or shift or misplace, thereby ensuring the reliability and stability of the fixing between the protective sleeve and the handrail body. Other adhering and fixing methods, which can achieve the adhering and fixing of the first adhesive layer 14 on the first protective layer 12, are within the scope of the present disclosure.

The second adhesive layer 15 may be adhered and fixed on a surface of the second protective layer 13 in contact with the first protective layer 12 by hot pressing or vacuum adsorption, so that the second adhesive layer 15 can be fixed on the second protective layer 13 in advance, which can prevent the second adhesive layer 15 from shifting or misplacing when the first protective layer 12 and the second protective layer 13 are adhered and fixed, so as to ensure the reliability of the adhering and fixing of the first protective layer 12 and the second protective layer 13. Other adhering and fixing methods, which can achieve the adhering and fixing of the second adhesive layer 15 on the second protective layer 13, are within the scope of the present disclosure.

Of course, it can be understood that a baking temperature is a constant temperature, that is, does not increase or decrease with a baking time.

It can be understood that the step (23) may also be after the step (22), that is, after the first protective layer and the second protective layer are adhered and fixed, the bending section may be adhered and fixed. In this way, the bending section can be adhered and fixed greatly, to ensure the covering effect on the end of the first protective layer.

It can be understood that the first protective layer 12 may also be a soft rubber structure or other foams.

It can be understood that the second protective layer 13 may also be made of PVC or a genuine leather or other leather materials.

It can be understood that the first protective layer 12 and the second protective layer 13 may also be fixed to each other by a glue, and it is simple, reliable and low in cost.

It can be understood that the bending section 131 may also be adhered and fixed with the first protective layer by a glue.

It can be understood that the second adhesive layer 15 may also be adhered and fixed on the surface of the first protective layer 12 in contact with the second protective layer 13 by hot pressing or vacuum adsorption. Other adhering and fixing methods, which can achieve the adhering and fixing of the second adhesive layer 15 on the first protective layer 12, are within the scope of the present disclosure.

It can be understood that in step (3), the base material layer may be curled, sewn or manually sewn into the protective sleeve matched with the handrail body 11. In this way, the method is simple and convenient for production and processing, and a sewing thread is formed at a joint of the protective sleeve, so that the texture and grade of the protective sleeve, the handrail assembly and the child carrier can be improved.

It can be understood that the baking temperature may also be 80° C., 85° C., 90° C., 95° C., 100° C., 105° C., 110° C., 115° C., 120° C., 125° C., 135° C., 140° C., 145° C., 150° C., etc., depending on the materials of the handrail body and the types of the hot melt adhesive membrane.

It can be understood that the baking time may also be 2 minutes, 2.5 minutes, 3 minutes, 3.5 minutes, 4.5 minutes, 5 minutes, 5.5 minutes, 6 minutes, etc., depending on the materials of the handrail body and the types of hot melt adhesive membrane.

It can be understood that the handrail body 11 may be a hollow plastic tube or a solid plastic tube. Preferably, the first adhesive layer 14 may be a PP hot melt adhesive membrane, which has better adhering effect and firmer adhering.

### The Eighth Embodiment

Referring to FIGS. 2 and 5, taking the specific structure of the handrail assembly in the third embodiment as an example, the handrail assembly 10 includes a handrail body 11, wherein the handrail body 11 is covered with a first protective layer 12 having a flexible structure, and the first protective layer 12 is covered with a second protective layer 13, and the second protective layer 13 shields the first protective layer 12 to prevent the first protective layer 12 from being exposed to the outside, and both ends of the second protective layer 13 are respectively bent and extended to form bending sections 131 that cover both ends of the first protective layer 12 respectively. A tip of the bending section 131 extends to an end of the handrail body 11 and is at least partially attached to the end of the handrail body 11. As shown in FIG. 7, this embodiment also provides a manufacturing method of the handrail assembly 10, which includes following steps of:
(1) providing a first protective layer 12, a second protective layer 13, and a first adhesive layer 14, wherein the first adhesive layer 14 is adhered to a surface of the first protective layer 12 in contact with the handrail body 11, and the first adhesive layer 14 is made of hot-melt material;
(21) providing a second adhesive layer 15 made of a hot-melt material, and adhering and fixing the second adhesive layer 15 on a surface of the second protective layer 13 in contact with the first protective layer 12 to form a base material layer blank;
(23) bending reserved sections at edges of the second protective layer downward to form bending sections and cover ends of the first protective layer, wherein a tip of the bending section extends to an end of the handrail body and is at least partially attached to the end of the handrail body;
(22) baking the base material layer blank at 130° C. for 4 minutes until the second adhesive layer 15 is completely melted, so that the second protective layer and the bending sections are adhered and fixed with the first protective layer after the second adhesive layer is completely melted, and cooling the base material layer blank to form a required base material layer;
(3) curling the base material layer into a protective sleeve matched with the handrail body 11, wherein the protective sleeve has a cylindrical structure, and the first adhesive layer 14 is located at an inner side of the protective sleeve;
(4) inserting the handrail body 11, which is matched with the protective sleeve, into the protective sleeve to form a handrail assembly blank;
(5) baking the handrail assembly blank at 130° C. for 4 minutes until the first adhesive layer 14 is completely melted;
(6) cooling the baked handrail assembly blank to form a required handrail assembly 10.

Specifically, the reserved section is formed at a part where the edge of the second protective layer 13 is not covered by the first protective layer 12 when the first protective layer 12 is adhered and fixed on the second protective layer 13, so that the reserved section is bent downward to form the bending section 131.

In this method, the bending sections and the processing method thereof are provided, and the end of the bending section extends to the end of the handrail body and is at least partially attached to the end of the handrail body, so that the length and the covering area of the bending section are increased, thereby reducing the possibility that the end of the first protective layer is exposed, and better guaranteeing the child’s life safety.

Specifically, the reserved section is formed at a part where the edge of the second protective layer 13 is not covered by the first protective layer 12 when the first protective layer 12 is adhered and fixed on the second protective layer 13, so that the reserved section is bent downward to form the bending section 131.

Specifically, the first protective layer 12 has a flexible and elastic structure, and the elastic structure has a buffering function, to prevent the child from bumping against the hard handrail assembly when leaning forward.

More specifically, the first protective layer 12 is made of a EVA foam and the second protective layer 13 is made of PU, to ensure that the formed protective sleeve has good protection effect, texture and high grade, and facilitate for adhering and fixing between the two protective layers. Also, it is not easy to loosen or delaminate or wrinkle, and has properties of good firmness, strong sense of integrated structure, good texture and good appearance. Meanwhile, these two materials are easy to be obtained, and the purchasing cost is relatively low, which can greatly reduce the production and processing cost.

Specifically, both the first adhesive layer 14 and the second adhesive layer 15 are membrane structures, which have good flatness and ductility, and are convenient to be placed and spread, to ensure that the adhesive layer is fixed without dislocation or shifting during subsequent baking and hot melting, thereby facilitating subsequent baking and hot melting, ensure the strength after being adhered such that the two protective layers cannot be loosen and the protective sleeve and the handrail body cannot be loosen, and thus ensure that the protective sleeve has a good protection effect.

More specifically, the handrail body 11 is a metal tube having a hollow structure, and the first adhesive layer 14 is a TPU hot melt adhesive membrane. The TPU hot melt adhesive membrane has a smooth surface, which facilitates the handrail body 11 to pass through the protective sleeve, facilitates for production and processing, and improves the production and processing efficiency. The handrail body is made of metal, and the TPU hot melt adhesive membrane has better adhering effect and firmer adhering. However, it is not limited by the present disclosure, and the first adhesive layer 113 may also be one of a PU hot melt adhesive membrane, a PP hot melt adhesive membrane, a PS hot melt adhesive membrane and a PA hot melt adhesive membrane.

The first adhesive layer 14 may be adhered and fixed on a surface of the first protective layer 12 in contact with the handrail body 11 by hot pressing or vacuum adsorption. In this way, the first adhesive layer 14 may be fixed conveniently and reliably, and may not fall off or shift or misplace, thereby ensuring the reliability and stability of the fixing between the protective sleeve and the handrail body. Other adhering and fixing methods, which can achieve the adhering and fixing of the first adhesive layer 14 on the first protective layer 12, are within the scope of the present disclosure.

The second adhesive layer 15 may be adhered and fixed on a surface of the second protective layer 13 in contact with the first protective layer 12 by hot pressing or vacuum adsorption, so that the second adhesive layer 15 can be fixed on the second protective layer 13 in advance, which can prevent the second adhesive layer 15 from shifting or misplacing when the first protective layer 12 and the second protective layer 13 are adhered and fixed, so as to ensure the reliability of the adhering and fixing of the first protective layer 12 and the second protective layer 13. Other adhering and fixing methods, which can achieve the adhering and fixing of the second adhesive layer 15 on the second protective layer 13, are within the scope of the present disclosure.

Of course, it can be understood that a baking temperature is a constant temperature, that is, does not increase or decrease with a baking time.

It can be understood that the step (23) may also be after the step (22), that is, after the first protective layer and the second protective layer are adhered and fixed, the bending section may be adhered and fixed. In this way, the bending section can be adhered and fixed greatly, so as to ensure the covering effect on the end of the first protective layer.

It can be understood that the first protective layer 12 may also be a soft rubber structure or other foams.

It can be understood that the second protective layer 13 may also be made of PVC or genuine leather or other leather materials.

It can be understood that the first protective layer 12 and the second protective layer 13 may also be fixed to each other by a glue, and it is simple, reliable and low in cost.

It can be understood that the bending section 131 may also be adhered and fixed with the first protective layer by a glue.

It can be understood that the second adhesive layer 15 may also be adhered and fixed on the surface of the first protective layer 12 in contact with the second protective layer 13 by hot pressing or vacuum adsorption. Other adhering and fixing methods, which can achieve the adhering and fixing of the second adhesive layer 15 on the first protective layer 12, are within the scope of the present disclosure.

It can be understood that in step (3), the base material layer may be curled, sewn or manually sewn into the protective sleeve matched with the handrail body 11. In this way, the method is simple and convenient for production and processing, and a sewing thread is formed at a joint of the protective sleeve, so that the texture and grade of the protective sleeve, the handrail assembly and the child carrier can be improved.

It can be understood that the baking temperature may also be 80° C., 85° C., 90° C., 95° C., 100° C., 105° C., 110° C., 115° C., 120° C., 125° C., 135° C., 140° C., 145° C., 150° C., etc., depending on the materials of the handrail body and the types of the hot melt adhesive membrane.

It can be understood that the baking time may also be 2 minutes, 2.5 minutes, 3 minutes, 3.5 minutes, 4.5 minutes, 5 minutes, 5.5 minutes, 6 minutes, etc., depending on the materials of the handrail body and the types of hot melt adhesive membrane.

It can be understood that the handrail body 11 may be a hollow plastic tube or a solid plastic tube. Preferably, the first adhesive layer 14 may be a PP hot melt adhesive membrane, which has better adhering effect and firmer adhering.

### The Ninth Embodiment

Referring to FIGS. 2 and 6, taking the specific structure of the handrail assembly in the fourth embodiment as an example, the handrail assembly 10 includes a handrail body 11, wherein the handrail body 11 is covered with a first protective layer 12 having a flexible structure, and the first protective layer 12 is covered with a second protective layer 13, and the second protective layer 13 shields the first protective layer 12 to prevent the first protective layer 12 from being exposed to the outside, and both ends of the second protective layer 13 are respectively bent and extended to form bending sections 131 that cover both ends of the first protective layer 12 respectively. The bending sections 131 bypass the ends of the first protective layer 12 and are embedded into a contact surface between the first protective layer 12 and the handrail body 11, and the bending sections 131 are attached and fixed to the outer surface of the handrail body 11. As shown in FIG. 7, this embodiment also provides a manufacturing method of the handrail assembly 10, which includes following steps of:
(1) providing a first protective layer 12, a second protective layer 13, and a first adhesive layer 14, wherein the first adhesive layer 14 is adhered to a surface of the first protective layer 12 in contact with the handrail body 11, and the first adhesive layer 14 is made of a hot-melt material;
(21) providing a second adhesive layer 15 made of a hot-melt material, and adhering and fixing the second adhesive layer 15 on a surface of the second protective layer 13 in contact with the first protective layer 12 to form a base material layer blank;
(23) bending reserved sections at edges of the second protective layer 13 downward to form bending sections 131 and cover the ends of the first protective layer 12, wherein the bending sections 131 bypass the ends of the first protective layer 12 and are embedded into a contact surface between the first protective layer 12 and the handrail body 11, and the bending sections 131 are attached and fixed to the handrail body 11;
(22) baking the base material layer blank at 130° C. for 4 minutes until the second adhesive layer 15 is completely melted, so that the second protective layer 13 and the bending sections 131 are adhered and fixed with the first protective layer 12 and the handrail body 11 after the second adhesive layer 15 is completely melted, and cooling the base material layer blank to form the required base material layer;
(3) curling the base material layer into a protective sleeve matched with the handrail body 11, wherein the protective sleeve has a cylindrical structure, and the first adhesive layer 14 is located at an inner side of the protective sleeve;
(4) inserting the handrail body 11, which is matched with the protective sleeve, into the protective sleeve to form a handrail assembly blank;
(5) baking the handrail assembly blank at 130° C. for 4 minutes until the first adhesive layer 14 is completely melted;
(6) cooling the baked handrail assembly blank to form a required handrail assembly 10.

Specifically, the reserved section is formed at a part where the edge of the second protective layer 13 is not covered by the first protective layer 12 when the first protective layer 12 is adhered and fixed on the second protective layer 13, so that the reserved section is bent downward to form the bending section 131.

In this method, the bending sections and the processing method thereof are provided, the bending sections bypass the ends of the first protective layer and are embedded into a contact surface between the first protective layer and the handrail body, and the bending sections is connected to the handrail body. In this way, a length of the end of the first protective layer covered by the first protective layer is increased, that is, outer and inner sides of the end of the first protective layer are both covered, and the bending section is clamped by the handrail body and the first protective layer, so that the bending section cannot be turned out, thereby better preventing the end of the first protective layer from being exposed, preventing the child from biting the exposed first protective layer and accidentally swallowing, and better ensuring the child’s life safety.

Specifically, the reserved section is formed at a part where the edge of the second protective layer 13 is not covered by the first protective layer 12 when the first protective layer 12 is adhered and fixed on the second protective layer 13, so that the reserved section is bent downward to form the bending section 131.

Specifically, the first protective layer 12 has a flexible and elastic structure, and the elastic structure has a buffering function, so as to prevent the child from bumping against the hard handrail assembly when leaning forward.

More specifically, the first protective layer 12 is made of a EVA foam and the second protective layer 13 is made of PU, to ensure that the formed protective sleeve has good protection effect, texture and high grade, and facilitate for adhering and fixing between the two protective layers. Also, it is not easy to loosen or delaminate or wrinkle, and has properties of good firmness, strong sense of integrated structure, good texture and good appearance. Meanwhile, these two materials are easy to be obtained, and the purchasing cost is relatively low, which can greatly reduce the production and processing cost.

Specifically, both the first adhesive layer 14 and the second adhesive layer 15 are membrane structures, which have good flatness and ductility, and are convenient to be placed and spread, to ensure that the adhesive layer is fixed without dislocation or shifting during subsequent baking and hot melting, thereby facilitating subsequent baking and hot melting, ensure the strength after being adhered such that the two protective layers cannot be loosen and the protective sleeve and the handrail body cannot be loosen, and thus ensure that the protective sleeve has a good protection effect.

More specifically, the handrail body 11 is a metal tube having a hollow structure, and the first adhesive layer 14 is a TPU hot melt adhesive membrane. The TPU hot melt adhesive membrane has a smooth surface, which facilitates the handrail body 11 to pass through the protective sleeve, facilitates for production and processing, and improves the production and processing efficiency. The handrail body is made of metal, and the TPU hot melt adhesive membrane has better adhering effect and firmer adhering. However, it is not limited by the present disclosure, and the first adhesive layer 113 may also be one of a PU hot melt adhesive membrane, a PP hot melt adhesive membrane, a PS hot melt adhesive membrane and a PA hot melt adhesive membrane.

The first adhesive layer 14 may be adhered and fixed on a surface of the first protective layer 12 in contact with the handrail body 11 by hot pressing or vacuum adsorption. In this way, the first adhesive layer 14 may be fixed conveniently and reliably, and may not fall off or shift or misplace, thereby ensuring the reliability and stability of the fixing between the protective sleeve and the handrail body. Other adhering and fixing methods, which can achieve the adhering and fixing of the first adhesive layer 14 on the first protective layer 12, are within the scope of the present disclosure.

The second adhesive layer 15 may be adhered and fixed on a surface of the second protective layer 13 in contact with the first protective layer 12 by hot pressing or vacuum adsorption, so that the second adhesive layer 15 can be fixed on the second protective layer 13 in advance, which can prevent the second adhesive layer 15 from shifting or misplacing when the first protective layer 12 and the second protective layer 13 are adhered and fixed, so as to ensure the reliability of the adhering and fixing of the first protective layer 12 and the second protective layer 13. Other adhering and fixing methods, which can achieve the adhering and fixing of the second adhesive layer 15 on the second protective layer 13, are within the scope of the present disclosure.

Of course, it can be understood that a baking temperature is a constant temperature, that is, does not increase or decrease with a baking time.

It can be understood that the step (23) may also be after the step (22), that is, after the first protective layer and the second protective layer are adhered and fixed, the bending section may be adhered and fixed. In this way, the bending section can be adhered and fixed greatly, so as to ensure the covering effect on the end of the first protective layer.

It can be understood that the first protective layer 12 may also be a soft rubber structure or other foam.

It can be understood that the second protective layer 13 may also be made of PVC or a genuine leather or other leather materials.

It can be understood that the first protective layer 12 and the second protective layer 13 may also be fixed to each other by a glue, and it is simple, reliable and low in cost.

It can be understood that the bending section 131 may also be adhered and fixed with the first protective layer by a glue.

It can be understood that the second adhesive layer 15 may also be adhered and fixed on the surface of the first protective layer 12 in contact with the second protective layer 13 by hot pressing or vacuum adsorption. Other adhering and fixing methods, which can achieve the adhering and fixing of the second adhesive layer 15 on the first protective layer 12, are within the scope of the present disclosure.

It can be understood that in step (3), the base material layer may be curled, sewn or manually sewn into the protective sleeve matched with the handrail body 11. In this way, the method is simple and convenient for production and processing, and a sewing thread is formed at a joint of the protective sleeve, so that the texture and grade of the protective sleeve, the handrail assembly and the child carrier can be improved.

It can be understood that the baking temperature may also be 80° C., 85° C., 90° C., 95° C., 100° C., 105° C., 110° C., 115° C., 120° C., 125° C., 135° C., 140° C., 145° C., 150° C., etc., depending on the materials of the handrail body and the types of the hot melt adhesive membrane.

It can be understood that the baking time may also be 2 minutes, 2.5 minutes, 3 minutes, 3.5 minutes, 4.5 minutes, 5 minutes, 5.5 minutes, 6 minutes, etc., depending on the materials of the handrail body and the types of hot melt adhesive membrane.

It can be understood that the handrail body 11 may be a hollow plastic tube or a solid plastic tube. Preferably, the first adhesive layer 14 may be a PP hot melt adhesive membrane, which has better adhering effect and firmer adhering.

Of course, it can also be understood that the handrail assembly mentioned in the above embodiments is a generic concept, that is, parts to be held by an occupant or a user all can be regarded as the handrail assembly, and may refer to a front handrail of the stroller facing the occupant, or refer to a handle or handlebar or gripper on the frame.

The above disclosure only discloses preferred embodiments of the present disclosure, and should not limit the protection scope of the present disclosure. Therefore, all equivalent changes made according to the claims of the present disclosure are within the scope of the present disclosure.

1-27. (canceled)

28. A handrail assembly, comprising:
a handrail body covered with a first protective layer having a flexible structure, the first protective layer covered with a second protective layer, the second protective layer shielding the first protective layer to prevent the first protective layer from being exposed to outside.

29. The handrail assembly according to claim 28, wherein both ends of the second protective layer are respectively bent and extended to form bending sections covering both ends of the first protective layer.

30. The handrail assembly according to claim 29, wherein a tip of the bending section extends to an end of the handrail body, the tip being at least partially attached to the end of the handrail body.

31. The handrail assembly according to claim 29, wherein the bending sections of the second protective layer bypass the ends of the first protective layer and are embedded into a contact surface between the first protective layer and the handrail body, the bending sections connected to the handrail body.

32. The handrail assembly according to claim 28, wherein the handrail body is a rigid tube having a hollow structure.

33. The handrail assembly according to claim 28, wherein the handrail body has an integrated structure.

34. The handrail assembly according to claim 28, wherein the first protective layer has an elastic structure.

35. The handrail assembly according to claim 34, wherein the first protective layer is a soft rubber structure or a foam structure.

36. The handrail assembly according to claim 1, wherein the second protective layer is a leather structure.

37. A method for manufacturing of a handrail assembly, the handrail assembly including a handrail body, comprising steps of:
(1) providing a first protective layer, a second protective layer and a first adhesive layer, wherein the first adhesive layer is provided on a surface of the first protective layer in contact with the handrail body, the first adhesive layer made of a hot-melt material;
(2) adhering and fixing the first protective layer and the second protective layer to form a base material layer having an integrated structure;
(3) curling the base material layer into a protective sleeve matched with the handrail body, wherein the protective sleeve has a cylindrical structure, the first adhesive layer located at an inner side of the protective sleeve;
(4) inserting the handrail body, which is matched with the protective sleeve, into the protective sleeve to form a handrail assembly blank;
(5) baking the handrail assembly blank until the first adhesive layer is completely melted; and
(6) cooling a baked handrail assembly blank to form a required handrail assembly.

38. The method according to claim 37, wherein the step (2) further comprises steps of:
(21) providing a second adhesive layer, wherein the second adhesive layer is made of a hot-melt material and provided between the first protective layer and the second protective layer; and
(22) adhering the first protective layer and the second protective layer into an integrated structure by being baked at a high temperature to form the base material layer.

39. The method according to claim 37, wherein the step (2) further comprises steps of:
(21) applying a glue between the first protective layer and the second protective layer; and
(22) adhering the first protective layer and the second protective layer into the integrated structure to form the base material layer after the glue is solidified.

40. The method according to claim 39, wherein the step (2) further comprises steps of:
(23) fixedly connecting the bending sections with the first protective layer.

41. The method according to claim 40, wherein the step (23) is prior to the step (22), the bending sections being capable of being fixed with the first protective layer together with the second protective layer.

42. The method according to claim 40, wherein the step (23), the bending sections are fixedly connected to the first protective layer by baking the second adhesive layer; or, in the step (23), the bending sections are fixedly connected to the first protective layer by the glue.

43. The method according to claim 37, wherein the step (3) further comprises a step of:
curling and sewing or manually sewing the base material layer into a protective sleeve matched with the handrail body.

44. The method according to claim 38, wherein each of the first adhesive layer and the second adhesive layer has a membrane structure.

45. The method according to claim 44, wherein each of the first adhesive layer and the second adhesive layer is selected from one of a PU hot melt adhesive membrane, a TPU hot melt adhesive membrane, a PP hot melt adhesive membrane, a PS hot melt adhesive membrane and a PA hot melt adhesive membrane.

46. The method according to claim 45, wherein the first adhesive layer and the second adhesive layer use different hot melt adhesive membranes.

47. The method according to claim 38, wherein the first adhesive layer is adhered and fixed with the first protective layer by hot pressing or vacuum adsorption or a double-sided adhesive layer; and/or, the second adhesive layer is adhered and fixed with the second protective layer or the first protective layer by hot pressing or vacuum adsorption or a double-sided adhesive layer.

48. The method according to claim 38, wherein a baking temperature in the steps (5) and (22) ranges from 80° C. to 150° C.

49. The method according to claim 38, wherein a baking time in the steps (5) and (22) ranges from 2 minutes to 6 minutes.

50. A support frame structure, comprising:
a front support assembly;
a rear support assembly;
a push rod assembly;
a connecting assembly assembling and connecting the front support assembly, the rear support assembly and the push rod assembly; and
a handrail assembly including a handrail body covered with a first protective layer having a flexible structure, the first protective layer covered with a second protective layer, the second protective layer shielding the first protective layer to prevent the first protective layer from being exposed to outside,
wherein a connecting portion of the handrail assembly is detachably connected to the connecting assembly.

51. The support frame structure according to claim 50, further comprising:
an inserting element provided at the connecting portion,
wherein the inserting element is detachably connected to the connecting portion.

52. The support frame structure according to claim 51, wherein the connecting assembly is provided with a receiving element matched with the inserting element of the handrail assembly, the handrail assembly being detachably connected to the connecting assembly through a plug-in connection between the inserting element and the receiving element.

53. The support frame structure according to claim 50, wherein the support frame structure is a stroller structure, a baby bed frame structure or a baby seat structure.

54. A child carrier, comprising:
a child carrier body; and
a support frame structure according to claim 50 supporting the child carrier body.
